(19) United States
(12) Patent Application Publication
(10) Pub. No.: US 2006/0280031 A1
(43) Pub. Date: Dec. 14, 2006

(54) System and Method for Interpreting Seismic Data

(75) Inventors: Anil K. Chopra, Plano, TX (US); Rajesh Kumar Bhairampally, Plano, TX (US); Bijoy Chattopadhyay, Plano, TX (US); Steven J. Malecek, Plano, TX (US); Stephen M. Nicolais, Plano, TX (US)

Correspondence Address: Plano Research Corporation;Suite 201, 5240 Tennyson Parkway, Plano, TX, 75024, US

(73) Assignee: PLANO RESEARCH CORPORATION, Plano, TX (US)

(21) Appl. No.: 11/160,163

(22) Filed: Jun. 10, 2005

(51) Int. Cl. G01V 1/00

(52) U.S. Cl. 367/68

(57) ABSTRACT

In accordance with the present invention, a system and a method for generating structural, stratigraphic and petro-physical interpretations of geophysical and geological data to produce sub-surface geologic maps, cross-sections, and models, are disclosed that provide additional advantages over and/or substantially reduce disadvantages associated with the previous methods of seismic data interpretation. The method for interpreting seismic data includes a touch screen based computer system that is easily operable to collect coordinate and other attribute data associated with seismic and well log information. The system is capable of giving the user a feel of virtual paper-pencil based interpretation by allowing the user to freely draw interpretations and annotations on the seismic and well log displays, and collecting all such annotation and interpretation data are stored as a set of points. The system also collects the structural, stratigraphic and petro-physical information and stores in the database.

Seismic information is essential in oil and gas exploration. Millions of dollars are invested in obtaining seismic data to minimize the risk of drilling multi million-dollar dry holes. Thus, it is essential in the art to have a system and method to correctly interpret seismic data, integrating it with other petro-physical data, and jointly evaluating these sets of data to optimize the location of expensive exploratory wells. The basic requirement is to establish a coherent structural and stratigraphic framework. The tools used to establish a relationship between the seismic and other petrophysical data with existing workstation capabilities involve tracking horizons with mouse clicks, drawing faults and fault polygons, girdding and contouring etc.

Furthermore, the existing tools require a high degree of repetitive hand and wrist motion using mouse clicks to pick seismic horizons and faults. Such repetitive hand and wrist motions pose health risks in the form of carpal tunnel syndrome. Horizon auto tracking and computer aided seismic facies pattern recognition methods attempt to mitigate these effects, but they are generally inadequate except for the most obvious and straight-forward correlations and seismic facies classifications.

Also, one of the limitations of existing seismic interpretation systems is that they do not allow complete integration of geophysical and geologic data in a straightforward and user-friendly manner. Extensive pre-conditioning and/or reformatting of different datasets is often necessary, and certain data in the form of text, figures, graphs, models, notes, and annotations cannot be accommodated as part of the interpretation process.

The main focus of the invention is to bring back some of the desirable comforts of old-fashioned paper and pencil based seismic data interpretation to the state of the art portable and desktop computer systems utilizing the advancements in the hardware and software technologies.

One of the main uses of seismic data is to explore oil and gas availability in a prospective oil and gas field. Such exploration process consists of studying the seismic patterns of the prospective fields and then determines if they have potential for yielding oil and gas. This requires accurate visualization and interaction of the seismic data patterns, and integration of the seismic data with well log information.

Although existing tools to visualize seismic data helped to automate certain seismic data interpretation aspects, these tools are confined to displaying the data on the computer screen in a 2D plane. As such, the flexibility of studying the seismic patterns from an inclined point of view and interacting with the seismic data on the computer display, that could have been easily done in paper-pencil format, are now missing. While some attempt is made by using the mouse to interact with the displayed seismic data, a high degree of repetitive hand and wrist motion using mouse clicks to pick seismic horizons and faults during the interpretation process creates a health risk in the form of carpal tunnel syndrome (CTS). CTS occur when the median nerve becomes pressed or squeezed at the wrist. The effect of CTS usually starts gradually, with frequent burning, tingling, or itching numbness in the palm of the hand and the fingers, especially the thumb and the index and middle fingers. Some carpal tunnel sufferers say their fingers feel useless and swollen, even though little or no swelling is apparent.

The seismic interpretation system that is claimed in this disclosure uses a computer system with a display device. One of such computer system is touch sensitive, and is generally known as “Tablet PC”. The disclosed system uses one of the above mentioned computer systems to interpret seismic data that is collected in an industry standard, known as the SEG-Y format. SEG-Y is the standard seismic data exchange format and is administered by the SEG (Society of Exploration Geophysicists) Technical Standards Committee The innovation that is disclosed here fills gaps in the interpretation system that are explained above. The disclosed system permits the users to view and interpret data in an inclined view and also allows users to interact with the displayed data with the help of input devices such as stylus or electromagnetic pen, or similar other input device, including, but not limited to mouse.

The system described in this disclosure consists of several subsystems including seismic optimization module, mapping module, geological fault module, well log module, time-depth conversion module, graphics module, horizon-picking module, user interface module, and database interaction module.

The main purpose of seismic optimization module is to optimize SEGY data for speedy retrieval, whereas mapping module maps the imported SEGY data on the base map. Base map gives the geographical location of seismic survey on the Earth's coordinate system. The geological fault module identifies, manages, and performs required computations including fault patterns, areas and volumes of fault polygons in the imported seismic data. The well log and time-depth conversion module converts the imported well log data from depth domain to time domain, and prepares data to be fed to the graphics module and to the database module. Database module saves the time-depth conversion data that is fed to it by the time-depth conversion module. Graphics module renders the imported well logs on the seismic with the help of time-depth conversion data fed by the time-depth conversion module. The graphics module allows users to interact with the well logs to make sure that the seismic data and the well log data matches well. Finally, the horizon-picking and interpretation module collects user input on the seismic display by capturing user events generated by input devices. Such collection also includes the geographical location data from the seismic display, stores all the collected data in the database by interacting with database module. This module also maintains a list of all such horizons from seismic survey. The graphical user interface module wraps all of these functions to present a workable platform for the user.

Detailed descriptions of the preferred embodiments of the invention are as follows:

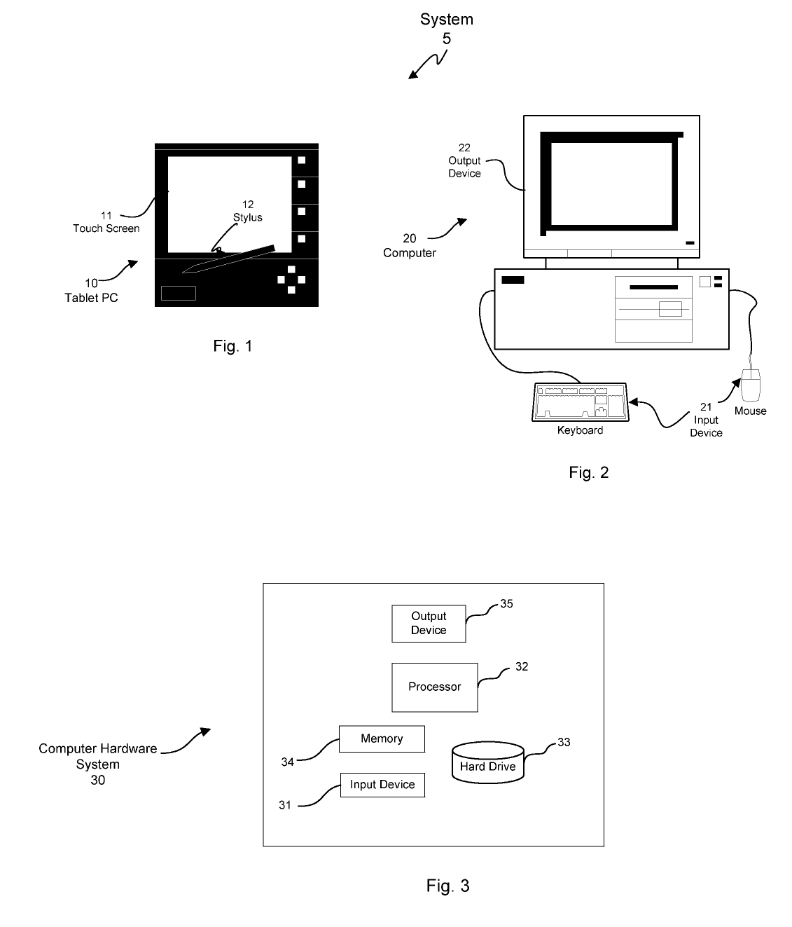

FIG. 1 shows one embodiment of computer system 10 that is compact and portable, known as “Tablet PC” that includes an electromagnetic sensitive touch-screen 11 and a stylus 12 that uses electro-magnetic field to interact with the screen 11. This type of system has an additional input device along with those for the system shown in FIG. 2, and is known as “stylus” or “digital pen” or “electromagnetic pen” or simply “pen”.

Referring to FIG. 2, in yet another embodiment, the computer system 20 shown in FIG. 2 includes one or more input devices 21 such as keypad, touch screen, mouse, microphone, or other suitable pointer or device that accepts information. An output device 22 such as speaker, monitor or other display devices conveys information associated with the operation of computer system 20. The computer system 20 may also include fixed or movable storage media such as magnetic computer disk, CD-ROM, or other suitable media to either receive output from, or provide input to, the computer system 20.

Referring to FIG. 3 of computer hardware system 40, one embodiment of computer system includes memory 34, one or more processor(s) 32, one or more hard drive(s) 33, standard input device interfaces 31 including, but not limited to, PS2 ports, USB ports, Serial and parallel ports, wireless and infrared ports, standard output interface ports 35 including, but not limited to, those for speakers and other audio devices, display monitor or other display devices and other similar video devices.

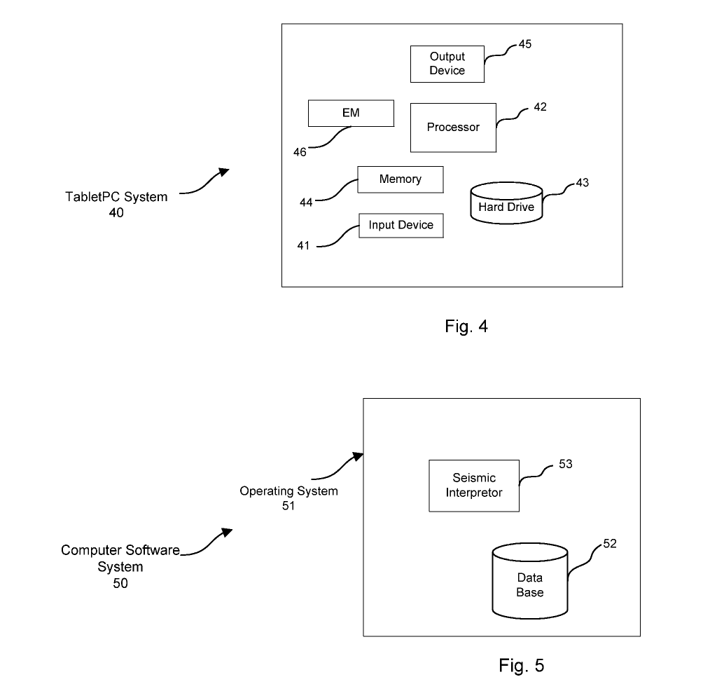

In reference to TabletPC system 40 and FIG. 4, one embodiment of computer system includes memory 44, one or more processor(s) 42, one or more hard drive(s) 43, standard input device interfaces 41 including, but not limited to, Electro-Magnetic field related input interfaces, PS2 ports, USB ports, Serial and parallel ports, wireless and infrared ports, standard output interface ports 45 including, but not limited to, those for speakers and other audio devices, display monitor or other display devices and other similar video devices.

FIG. 5, computer system 50, shows one embodiment of software configuration that is required to run seismic interpretation system software 53, which includes the operating system 51 that provides a graphical windowing system, seismic interpretation software 53 and a database 52.

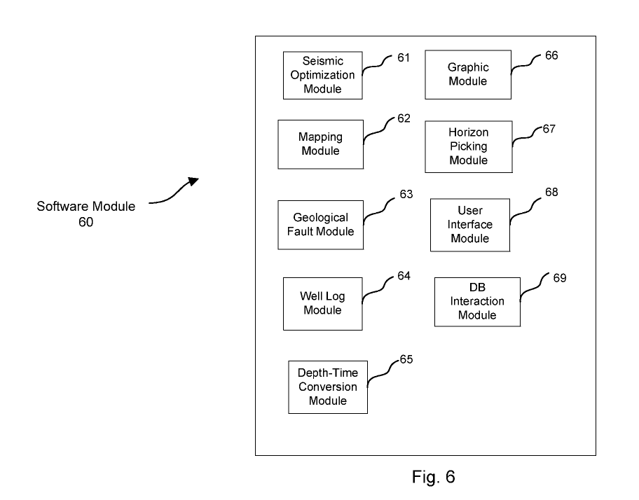

FIG. 6 shows one embodiment of seismic interpretation system software 60 that includes a collection of modules consisting of, but not limited to, seismic optimization module 61, mapping module 62, geological fault module 63, well logs and synthetics module 64, depth-time conversion module 65, graphics display module 66, horizon picking module 67, graphical user interface module 68, and database interaction module 69.

The seismic optimization module 61 imports a file in a file format known as SEG-Y that is in compliance with standard seismic data exchange format that is administered by the SEG (Society of Exploration Geophysicists) Technical Standards Committee. Importing SEG-Y file consists of optimizing the original file structure for speedy retrieval of data from storage devices, including volatile, non-volatile, local, and network attached storage devices. During the optimization process, the module 61 interacts with database module 69 to save the location of the optimized data.

The mapping module 62 maps the imported seismic data by interacting with module 61 to the geographical coordinate system that includes latitude, longitude, azimuth, and a map projection system. The mapping module 62 takes inputs either as latitudes and longitudes or Cartesian coordinates on the globe. Such location inputs are combined with the location information of the imported seismic data to enable visualization of seismic data on a geographical coordinate system.

The geological fault module 63 identifies, manages, and performs required computations including fault patterns, areas and volumes of fault polygons in the imported seismic data.

The well logs and synthetics module 64 allows users to load well log data into the seismic interpretation software 53 and display on top of a seismic section. The module 64 requires that the well log data be in the same domain as that of seismic data.

The depth-time conversion module 65 is invoked by well log synthetics module 64 to convert well log data from depth domain to time domain, for displaying well log information on top of seismic data.

The graphics module 66 prepares the visual representation of seismic and/or well logs data, and invokes appropriate responses to the user events. For the purpose of visual representation of seismic and/or well log data, the module 66 also prepares the display device 12 and/or 22 for rendering display, arranges the necessary lighting, pixel level shading, color, and texture properties to the data.

The horizon-picking module 67 collects user input on the seismic display by capturing mouse clicks, inputs from stylus movements, inputs from electromagnetic field sensitive pens, and other similar input devices on the displayed seismic data. Such collection also includes the geographical location data from the seismic display, stores all the collected data in the database by interacting with database interaction module 69, and maintains a list of all such horizons from seismic survey.

The graphical user interface module 68 interacts with the operating system 51 to display windows, menus, tool bars, workspace trees and other components along with allocating display space for graphics module 66. The module 68 interacts directly with the user events caused by stylus movements and similar other input devices, including, but not limited to, mouse clicks, keystrokes, and distributes such events to appropriate modules when a response to such user event is expected.

The database interaction module 69 is an interface to the database 52. All other modules, which requires access to database has to call the required member function. These member functions returns the results of database query to the calling function.

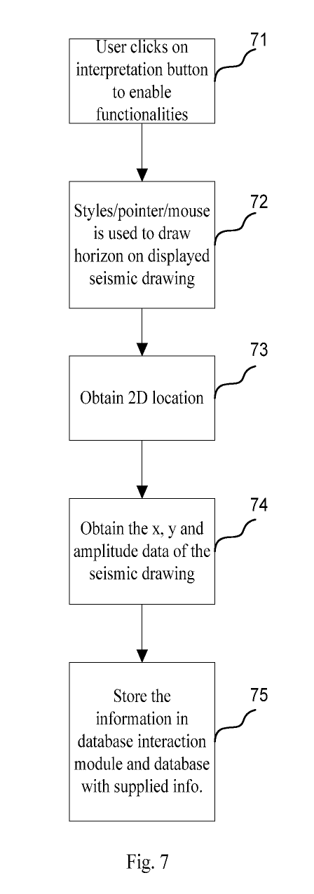

Referring to FIG. 7, the horizon interpretation process is shown, in which user starts interpreting the seismic data by invoking the interpretation option in step 71. Such option is achieved by importing the seismic data by interacting with module 61 in FIG. 6 and displayed by interacting with module 66 in FIG. 6.

Referring to step 72 of FIG. 7, the graphics module 66 prepares to accept and respond to user events that are triggered by electromagnetic pen devices or any type of input device including, but not limited to, mouse, stylus, any other pointing device, or other. Such input devices are used in drawing the horizon over a seismic pattern on the seismic display in a similar manner that of drawing on a paper with a pencil.

Referring to 73 of FIG. 7, the graphics module collects the points of contacts or screen coordinates pointed by input devices on the display screen and calculates the corresponding position in the displayed visualization. The module 66 then determines corresponding seismic data for all points of contacts or screen coordinates directed by input devices.

Referring to step 74 of FIG. 7, the graphics module 66 extracts the geographical location of collected data in step 73 along with other properties user may choose to save with the horizon.

Referring to step 75 of FIG. 7, the graphics module 66 interacts with database interaction module 69 to save data extracted in step 74.

What is claimed is:

1. A system for interpreting seismic data, said system comprising:
a computer with display device;
a computer with display operable to interpret seismic data associated with SEG-Y data files;
a computer with a screen that is capable of accepting inputs from key board enabled input devices;
a pointing device at least including computer mouse operable to interpret data associated with seismic data file.

2. The system of claim 1, wherein said computer includes an optimization module when executed by said computer saves seismic data in a format that is favorable to faster retrieval from the disk.

3. The system of claim 1, wherein said computer includes an optimization module operable when executed by said computer to display seismic data quickly.

4. The system of claim 1, wherein said computer includes a geological fault implementation module operable when executed by said computer to create fault planes that help in identifying geological discontinuities that is key to and/or play a role in oil and gas entrapment.

5. The system of claim 1, wherein said computer includes a geological fault implementation module when executed by said computer to create fault line that help in identifying geological discontinuities that are key to and/or play a role in oil and gas entrapment.

6. The system of claim 1, wherein said computer includes a geological fault implementation module operable when executed by said computer to create fault polygons that help in identifying geological discontinuities that are key to and/or play a role in oil and gas entrapment.

7. The system of claim 1, wherein said computer includes an optimized real-time graphics rendering module operable when executed by said computer to display 3-Dimensional seismic volumes faster in an interactive display mode.

8. The system of claim 1, wherein said computer includes an optimized real-time graphics rendering module operable when executed by said computer to display 2-Dimensional seismic planes.

9. The system of claim 1, wherein said computer includes an optimized database module operable when executed by said computer to retrieve mapping data for the geographic location of oil and gas prospect survey.

10. The system of claim 1, wherein said computer includes an optimized database module operable when executed by said computer to retrieve mapping data for the geographic location of seismic survey.

11. The system of claim 1, wherein said computer includes an optimized real-time graphics subroutine operable when executed by said computer to zoom seismic and/or well log data.

12. The system of claim 1, wherein said computer includes an optimized real-time graphics subroutine operable when executed by said computer to zoom interpreted horizons.

13. The system of claim 1, wherein said computer includes an optimized real-time graphics subroutine operable when executed by said computer to zoom 2-dimensional seismic planes.

14. The system of claim 1, wherein said computer includes an optimized real-time graphics subroutine operable when executed by said computer to rotate 3-dimensional seismic volumes.

15. The system of claim 1, wherein said computer includes an optimized real-time graphics subroutine operable when executed by said computer to rotate 2-dimensional seismic planes.

16. The system of claim 1, wherein said computer includes an optimized real-time graphics subroutine operable when executed by said computer to rotate 3-dimensional horizon slices.

17. The system of claim 1, wherein said computer includes an optimized real-time graphics display subroutine operable when executed by said computer to render an integrated display well logs and the related properties and enable users to comprehensively review and interact with the data.

18. The system of claim 1, wherein said computer includes a performance-optimized module operable when executed by said computer to create and display synthetic seismic traces and enables the user to easily resize the synthetic seismic trace display to obtain a better fit with the actual seismic data obtained from the survey.

19. The system of claim 1, wherein said computer includes a module operable when executed by said computer to create and/or modify well log data, including, but not limited to, Lithology.

20. The system of claim 1, wherein said computer includes a module operable when executed by said computer deduces time-depth relationship from the synthetic seismic traces generated in claim 18.

21. The system of claim 1, wherein said computer includes an optimized real-time graphics display subroutine operable when executed by said computer to render an integrated display of well logs on the seismic data and enable users to comprehensively review and interact with the data.

22. The system of claim 1, wherein said computer includes an optimized real-time graphics subroutine operable when executed by said computer to interactively annotate on 3-Dimensional seismic volumes.

23. The system of claim 1, wherein said computer includes an optimized real-time graphics subroutine operable when executed by said computer to interactively annotate on 2-Dimensional seismic planes.

24. A system for interpreting seismic data, said system comprising:
a computer with display on a touch sensitive screen operable to interpret seismic data associated with SEG-Y data files;
a computer with a screen that is capable of accepting inputs from electro-magnetic field enabled input devices;
a digital pen stylus operable to interpret data associated with seismic data file;
a stylus operable to interpret data associated with seismic data file;
a digital pen with electro-magnetic field operable to interpret data associated with seismic data file.

25. The system of claim 24, wherein said computer includes an optimization module when executed by said computer saves seismic data in a format that is favorable to faster retrieval from the disk.

26. The system of claim 24, wherein said computer includes an optimization module operable when executed by said computer to display seismic data quickly.

27. The system of claim 24, wherein said computer includes a geological fault implementation module operable when executed by said computer to create fault planes that help in identifying geological discontinuities that is key to and/or play a role in oil and gas entrapment.

28. The system of claim 24, wherein said computer includes a geological fault implementation module when executed by said computer to create fault line that help in identifying geological discontinuities that are key to and/or play a role in oil and gas entrapment.

29. The system of claim 24, wherein said computer includes a geological fault implementation module operable when executed by said computer to create fault polygons that help in identifying geological discontinuities that are key to and/or play a role in oil and gas entrapment.

30. The system of claim 24, wherein said computer includes an optimized real-time graphics rendering module operable when executed by said computer to display 3-Dimensional seismic volumes faster in an interactive display mode.

31. The system of claim 24, wherein said computer includes an optimized real-time graphics rendering module operable when executed by said computer to display 2-Dimensional seismic planes.

32. The system of claim 24, wherein said computer includes an optimized database module operable when executed by said computer to retrieve mapping data for the geographic location of oil and gas prospect survey.

33. The system of claim 24, wherein said computer includes an optimized database module operable when executed by said computer to retrieve mapping data for the geographic location of seismic survey.

34. The system of claim 24, wherein said computer includes an optimized real-time graphics subroutine operable when executed by said computer to zoom seismic and/or well log data.

35. The system of claim 24, wherein said computer includes an optimized real-time graphics subroutine operable when executed by said computer to zoom interpreted horizons.

36. The system of claim 24, wherein said computer includes an optimized real-time graphics subroutine operable when executed by said computer to zoom 2-dimensional seismic planes.

37. The system of claim 24, wherein said computer includes an optimized real-time graphics subroutine operable when executed by said computer to rotate 3-dimensional seismic volumes.

38. The system of claim 24, wherein said computer includes an optimized real-time graphics subroutine operable when executed by said computer to rotate 2-dimensional seismic planes.

39. The system of claim 24, wherein said computer includes an optimized real-time graphics subroutine operable when executed by said computer to rotate 3-dimensional horizon slices.

40. The system of claim 24, wherein said computer includes an optimized real-time graphics display subroutine operable when executed by said computer to render an integrated display well logs and the related properties and enable users to comprehensively review and interact with the data.

41. The system of claim 24, wherein said computer includes a performance-optimized module operable when executed by said computer to create and display synthetic seismic traces and enables the user to easily resize the synthetic seismic trace display to obtain a better fit with the actual seismic data obtained from the survey.

42. The system of claim 24, wherein said computer includes a module operable when executed by said computer to create and/or modify well log data, including, but not limited to, Lithology.

43. The system of claim 24, wherein said computer includes a module operable when executed by said computer deduces time-depth relationship from the synthetic seismic traces generated in claim 18.

44. The system of claim 24, wherein said computer includes an optimized real-time graphics display subroutine operable when executed by said computer to render an integrated display of well logs on the seismic data and enable users to comprehensively review and interact with the data.

45. The system of claim 24, wherein said computer includes an optimized real-time graphics subroutine operable when executed by said computer to interactively annotate on 3-Dimensional seismic volumes.

46. The system of claim 24, wherein said computer includes an optimized real-time graphics subroutine operable when executed by said computer to interactively annotate on 2-Dimensional seismic planes.
